(19) United States
(12) Patent Application Publication
(10) Pub. No.: US 2023/0294168 A1
(43) Pub. Date: Sep. 21, 2023

(54) 3D-Metal-Printing Method and Arrangement Therefor

(71) Applicant: Value & Intellectual Properties Management GMBH, Bruckmühl (DE)

(72) Inventors: Kai Bär, Bad Aibling (DE); Andreas Geitner, Rottach-Egern (DE)

(73) Assignee: Value & Intellectual Properties Management GMBH, Bruckmühl (DE)

(21) Appl. No.: 18/324,011

(22) Filed: May 25, 2023

Related U.S. Application Data
(63) Continuation of application No. 16/759,460, filed on Apr. 27, 2020.

(30) Foreign Application Priority Data
Nov. 2, 2017 (DE) 10 2017 125 597.4

(51) Int. Cl. B22F 3/24; B33Y 10/00; B33Y 30/00; B23K 26/082; B23K 26/12; B23K 26/342; B33Y 40/20; B33Y 40/10; B23K 15/00; B23K 15/06; B23K 26/00; B23K 37/00; B22F 10/28; B22F 12/13; B22F 10/64; B22F 1/142

(52) U.S. Cl. CPC B22F 3/24; B22F 1/142; B22F 10/28; B22F 10/64; B22F 12/13; B23K 15/002; B23K 15/0086; B23K 15/0093; B23K 15/06; B23K 26/0006; B23K 26/082; B23K 26/1224; B23K 26/342; B23K 37/00; B33Y 10/00; B33Y 30/00; B33Y 40/10; B33Y 40/20; B22F 12/49; B22F 2003/248

(57) ABSTRACT

A 3D-metal-printing method applies material layer-by-layer and selectively locally heats predetermined points above a sintering or melting temperature of the powder and sinters or fuses the melted points with the underlying layer and optionally tempers the points. The starting material layer and optionally at least one underlying layer is preheated to a temperature with a predetermined difference to the melting temperature, and near IR radiation is sequentially irradiated in sections into partial sections of the total area of the respective starting material layer, wherein the selective local heating above the sintering or melting temperature is carried out in each case for predetermined points within a preheated partial section.

### CROSS REFERENCE TO RELATED DOCUMENTS

The instant application is a continuation of pending application 16/759,460 filed Apr. 27, 2020 and claims priority to that application. All disclosure of the parent application is incorporated at least by reference.

### BACKGROUND OF THE INVENTION

### 1. Field of the Invention

The present invention is in the technical field of 3D metal printing.

### 2. Description of Related Art

In recent years, a large number of methods have been developed for the layered construction of spatial metal products, which are summarized under the terms “additive manufacturing” or “3D printing”. These methods are partly based on melting and solidification steps and then include selective local heating of previously applied layers of material, which is also referred to here as “point-by-point” or “point-scanning” heating. For the manufacture of metal products, in particular from relatively high-melting metals such as titanium, a laser beam or electron beam which can be moved over the material layers under coordinate control is usually used.

In practice, laser beam methods dominate, which have to use a high-energy laser beam because of the high temperatures required for local melting of the top layer of the product under construction. Due to the softening and thermal stresses that occur in the top layer, depending on the product geometry, sometimes complex support structures are required, which must be removed from the finished product at great expense. The high temperatures also lead to an undesired “caking” (cakes) of the starting material powder or the starting material filaments outside the contour of the product to be manufactured. Removing such caked powder or filament portions from the finished product also requires effort and often leaves an unwanted uneven product surface. Caked starting material cannot be recovered and used for the manufacture of other products without further measures, so that the utilization of the starting material in such methods leaves much to be desired.

As a rule, the finished products must be subjected to a subsequent thermal treatment (tempering, annealing) to relieve stress due to the punctual thermal stresses that occur in the manufacturing process. Depending on the size and geometry of the product, this takes a considerable amount of time and thus seriously reduces the productivity of laser-based methods.

Electron beam methods (EBM process) require a high level of equipment and can only be used economically for products with relatively small dimensions and are therefore still not very widespread. They usually involve preheating the uppermost layer of material before local melting by means of a “stochastic” scanning of the entire surface with the electron beam, which further increases the equipment and control requirements and also considerably extends the production time of the product. On the other hand, thermal stresses are much less pronounced here, and the above-mentioned measures to control or eliminate their consequences are largely omitted.

What is needed is an improved method for the layered construction of spatial metal products.

### BRIEF SUMMARY OF THE INVENTION

In one embodiment of the invention a 3D-metal-printing method for producing a spatial metal product essentially from a metal powder or metal filaments is provided, wherein the powder or the filaments is/are built up layer-by-layer by applying starting material layers to a respective previously produced layer and selectively locally heating predetermined points of the layer above a sintering or melting temperature of the powder and sintering or fusing the melted points with the underlying layer and optionally tempering the points, wherein the respective newly applied starting material layer and optionally at least one underlying layer is preheated to a temperature with a predetermined difference to the melting temperature by irradiation in a flat or migrating manner of near IR radiation, in particular with a radiation density maximum in the wavelength range between 0.8 and 1.5 µm, and/or is post-treated following the local heating of predetermined points for thermal stress equalization, and wherein the near IR radiation is sequentially irradiated in sections into partial sections of the total area of the respective starting material layer, wherein the selective local heating above the sintering or melting temperature is carried out in each case for predetermined points within a preheated partial section.

In one embodiment the power density of the near IR radiation irradiated over a surface is above 1 MW/m². Also in one embodiment the radiation of at least one halogen radiator, in particular a plurality of halogen radiators, with a radiator temperature in particular also in the range of 2900 K to 3200 K is used as near IR radiation. In one embodiment the selective local heating of predetermined points is affected by scanning the starting material layer with an electron or laser beam. And in one embodiment preheating to a material-specific preset temperature, in particular in the range between 600 and 1100° C., more particularly in the range between 700 and 1000° C., is carried out and is controlled in particular by time and/or radiation density control of the irradiation of the near IR radiation.

In one embodiment a system for 3D metal printing is provided, comprising a worktable as a base for layer-by-layer structure of a spatial metal product, a powder application device for sequential application of starting material layers of a metal powder or starting material filaments in the area of the worktable, a surface heating device for surface heating of each new starting material layer for preheating or thermal post-treatment, the surface-heating device having an NIR irradiation device for irradiating near IR radiation, in particular with a radiation density maximum in the wavelength range between 0.8 and 1.5 µm, onto a predetermined surface in the region of the worktable, and a mechanism providing selective local heating of predetermined points of the new starting material layer above a sintering or melting temperature of the metal powder, wherein the surface heating device is designed to radiate the near IR radiation sequentially into subsections of the total area of the respective initial material layer, and wherein the means of inducing selective local heating are configured to induce local heating at specified points within one or another of the pre-heated subsections.

In one embodiment of the system the mechanism providing selective local heating of predetermined points of a previously applied starting material layer comprises a laser with a downstream scanner for point-by-point irradiation of near NIR radiation or visible light in the long-wave range onto the predetermined points. Also, in one embodiment the mechanism providing selective local heating of predetermined points of a previously applied starting material layer comprises an electron beam generator for the point-by-point irradiation of electron radiation onto the predetermined points, and the arrangement is arranged in a vacuum chamber subjected to a high vacuum.

In one embodiment of the system the NIR irradiation device comprises at least one halogen radiator, in particular a plurality of halogen radiators, with a reflector associated such that the radiation of the or each infrared radiator is concentrated in the direction towards the worktable. In one embodiment the halogen radiator or the plurality of halogen radiators with associated reflector is mounted above the worktable so as to be movable in at least one axial direction of an XY plane. And in one embodiment the halogen radiator or radiators is/are designed for operation at a radiator temperature in the range of 2900 K to 3200 K.

### BRIEF DESCRIPTION OF THE SEVERAL VIEWS OF THE DRAWINGS

FIG. 1 shows a schematic representation, in the manner of a longitudinal section, of an arrangement and a method according to an embodiment of the invention,

FIG. 2 shows a schematic representation, in the manner of a longitudinal section, of an arrangement and a method according to a further embodiment of the invention, and

FIG. 3 shows a schematic representation, in the manner of a longitudinal section, of an arrangement and a method according to a further embodiment of the invention.

### DETAILED DESCRIPTION OF THE INVENTION

The invention relates to a 3D-metal-printing method for producing a spatial metal product essentially from a metal powder or metal filaments, wherein the metal product is built up layer-by-layer by applying starting material layers to a respective previously produced layer and selectively locally heating predetermined points of the layer above a sintering or melting temperature and sintering or fusing the molten points with the underlying layer and subsequently tempering (annealing) them at the corresponding points, and wherein a preheating of the existing partial metal product and/or a thermal post-treatment is carried out. It further relates to an arrangement for carrying out such a method.

The invention is based on the object of specifying an improved method of the generic type and an arrangement for its implementation, with which high productivity, economical use of material and moderate energy consumption and thus overall reduced product costs can be achieved while at the same time meeting high quality requirements.

It is an idea of the present invention to carry out preheating prior to the local, “point-by-point” melting of newly applied layers of material only in the areas (layers) of the resulting metal product which are actually to be processed. According to a relatively independent aspect of the invention, a thermal post-treatment immediately after the local melting is carried out equally in the areas or layers. A further idea of the invention is to achieve at least one of both by using a radiation with a relatively small penetration depth, namely near IR radiation (NIR radiation), in particular with a radiation density maximum in the wavelength range between 0.8 and 1.5 µm.

In practically significant embodiments, aluminum, stainless steel, or titanium powder, or refractory metal powder, or powder made of alloys with these metals, is used as metal powder. In principle, the method can also be carried out with starting materials in filament form or also as granulate.

In one embodiment, the near IR radiation is irradiated sequentially in sections into partial sections of the total area of the respective starting material layer, wherein the selective local heating via the sintering or melting temperature is carried out in each case for predetermined points within a preheated partial section. The preheating or stress-reducing surface post-heating thus “migrates” in a preparatory and accompanying manner with the local heating over the sintering or melting temperature across the surface of the respective material layer to be treated.

In appropriate embodiments of the method, the power density of the near IR radiation irradiated in a flat or “migrating” manner is above 1 MW/m², and the radiation of at least one substantially linear halogen radiator, in particular a plurality of halogen radiators, with a radiator temperature of up to 3200 K, in particular in the range from 2900 K to 3200 K, is used as near IR radiation.

As in conventional methods, in a further embodiment the selective local heating of predetermined points for sintering or melting and for tempering is affected by scanning the starting material layer with an electron or laser beam.

In further embodiments of the proposed method it is provided that a preheating temperature selected as a function of the melting temperature and other parameters of the metal or alloy to be processed is set, in particular in the range between 600 and 1100° C., more specifically 700 and 1000° C., and is controlled in particular by time and/or radiation density control of the surface irradiation of the near IR radiation.

Attention is drawn to the following aspects of the invented device:

While the structure of the overall arrangement largely corresponds to that of known 3D printers, whose function is based on the sequential local melting of metal powders or metal filaments applied in layers, a special feature is the design of the device for heating the surface of the uppermost starting material layer, in the sense of preheating before local melting and/or thermal post-treatment for stress equalization immediately after melting. This device has an NIR irradiation device for irradiating near IR radiation, in particular with a radiation density maximum in the wavelength range between 0.1 and 1.5 µm, with high power density onto a predetermined surface in the area of the worktable.

The term “in the area of the worktable” is to be understood in a general sense and does not necessarily mean that the NIR irradiation device is placed vertically above the worktable, nor does it necessarily mean that its lateral extension is the same as that of the worktable. If the reflector geometry is suitable, the IR radiation device may have a smaller surface area than the worktable and may also be positioned obliquely above or even to the side of the worktable.

When using the present invention in the context of the EBM method, which is carried out in a high vacuum, the NIR irradiation device shall be placed and operated in particular in the vacuum chamber, and it needs to be positioned in such a way that any disturbance of the scanning of the product surface by the electron beam is prevented. In a practically proven design, the NIR irradiation device comprises at least one linear halogen radiator, in particular a plurality of halogen radiators, with an associated reflector such that the radiation of the or each infrared radiator is concentrated in the direction of the worktable. In other designs, however, the IR irradiation device may also comprise an array of high-power NIR laser diodes, and in such an embodiment, special reflectors can largely be dispensed with.

In a further design, the majority of halogen radiators with associated reflectors are mounted above the worktable so that they can be moved in a position-controlled manner in at least one axial direction of an XY plane. This embodiment is used to implement a method control in which the preheating is only carried out respectively for a specific part of the surface of the metal product that is being formed and this area “migrates” over the surface to be processed. Alternatively, it may be provided that the majority of halogen radiators with associated reflector is mounted in a stationary or, if necessary, height-adjustable manner above the worktable.

In a manner known per se, the means for effecting selective local heating of predetermined points of a pre-applied starting material layer may comprise an electron beam gun or a laser with a downstream scanner for the point-by-point irradiation of near NIR radiation or visible light in the long-wave range onto the predetermined points. The invention thus provides, at least in certain embodiments, several considerable advantages over prior art methods.

In particular, heating essentially only the last starting material layer immediately before local sintering or fusing allows the avoidance of large workpiece volumes and is thus basically energy-saving and reduces the thermal load on the entire device.

In addition, the invention reduces the permanent exposure of relatively high temperatures to programmatically non-sintered or fused areas of starting material layers processed in previous method steps and thus unintended softening and deterioration of the non-sintered powder in those layers, which can significantly improve the efficiency of recovering recyclable metal powder after a product is finished.

Since, according to the invention, larger temperature differences can be set between the “points” of the powder or filament layers to be fused and those not to be fused, such undesirable softening effects are significantly reduced, if not completely eliminated. If conventional methods often require the finished product to be cleaned of such adhering softening areas with much effort, such cleaning steps can be largely dispensed with when applying the invention. In addition, screening or other treatment of the starting material returned from the process can be largely dispensed with.

Especially in comparison to the known laser-based methods, in which support structures are provided on the product, the invention further provides the advantages of substantial saving of time and costs due to the extensive omission of such support structures and thus also the omission of the post-processing steps for their removal. Equally important is the time saving and the resulting productivity advantage due to the omission or at least the shortening of the thermal overall post-processing of the finished product for stress relief.

The arrangement in embodiments of the invention comprises a worktable 103, on which the metal powder bed 101 is applied layer-by-layer and the metal product P is formed. As symbolized by the arrow A, the worktable 103 can be moved vertically in order to keep the surface of the metal powder bed 101 at the same height level despite the fact that the height increases with the layer application. A powder application device for feeding metal powder into the actual working area comprises a punch 105, which is vertically movable in the direction of the arrow B, i.e. in the opposite direction to arrow A, and a powder application roller 107, which is movable in the direction of arrow C and moves metal powder 109 received as a supply on the punch 105 in individual layers of predetermined thickness into the working area (i.e. in the figure to the right into the powder bed 101).

An NIR radiation source 111, which in the example is formed by a single halogen lamp and an associated reflector 111b, is positioned above the working area. The NIR radiation source 111, as symbolized by the arrows D1 and D2, can be moved laterally back and forth across the powder bed 101 and serves to preheat the respectively irradiated sections of the powder bed to a temperature below a sintering or melting temperature of the metal powder. Optionally, it can also be used for thermal post-treatment (annealing) of a layer that has been locally melted immediately before, which can be carried out, for example, by “retracting” the NIR radiation source in the direction of arrow D2, if the radiation source has been moved over the surface of the powder bed 101 in the direction of arrow D1 for preheating. The NIR radiation source 111 can also comprise several halogen lamps with a reflector that is then shaped accordingly.

A commercial processing laser 113, selected with regard to the absorption properties of the metal powder to be processed and of course under cost aspects, with a downstream scanner 115 is arranged above the working area. The laser 113 and scanner 115 are designed in such a way that the surface of the powder bed 101 can be scanned with a laser beam L in order to heat the powder bed 101, which is preheated by the NIR radiation on its surface, above the sintering or melting temperature at the points of impact predetermined according to the product geometry. This causes a sintering with the respectively underlying layer at those points, thus forming the next layer of the metal product P. In a method control specific to the structure of certain metallic products, in a second scanning pass with the laser radiation already used for sintering or melting, an annealing of the sintered or fused areas is carried out to set desired mechanical properties. However, as mentioned above, this step can be replaced according to the invention by a stationary or “migrating” irradiation of the uppermost material layer with NIR radiation. In the usual way, the metal powder 109 remains in the powder state in those places where it has not been heated above the sintering or melting temperature and, after removal from the worktable, falls off the metal product P or can be washed out of it.

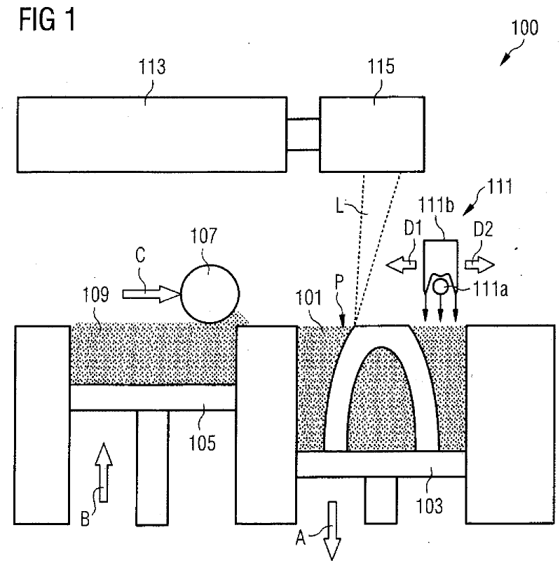

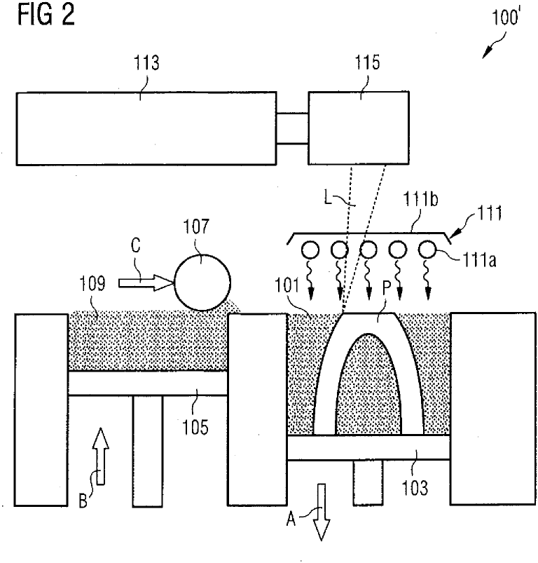

FIG. 2 shows an arrangement 100′ which is very similar to arrangement 100 according to FIG. 1, in which the matching parts are marked with the same reference numbers as in FIG. 1 and are not explained again here. The essential difference to arrangement 100 is that instead of a laterally movable NIR irradiation device, a stationary NIR irradiation device 111′ with a simple large-area reflector 111b and a row of halogen lamps 111a arranged below is provided here. It is understood that the relative arrangement of laser 113 and scanner 115 on the one hand and the NIR irradiation device 111 on the other hand must be determined in such a way that the radiation from both radiation sources can reach the entire surface of the powder bed 101 to be processed unhindered.

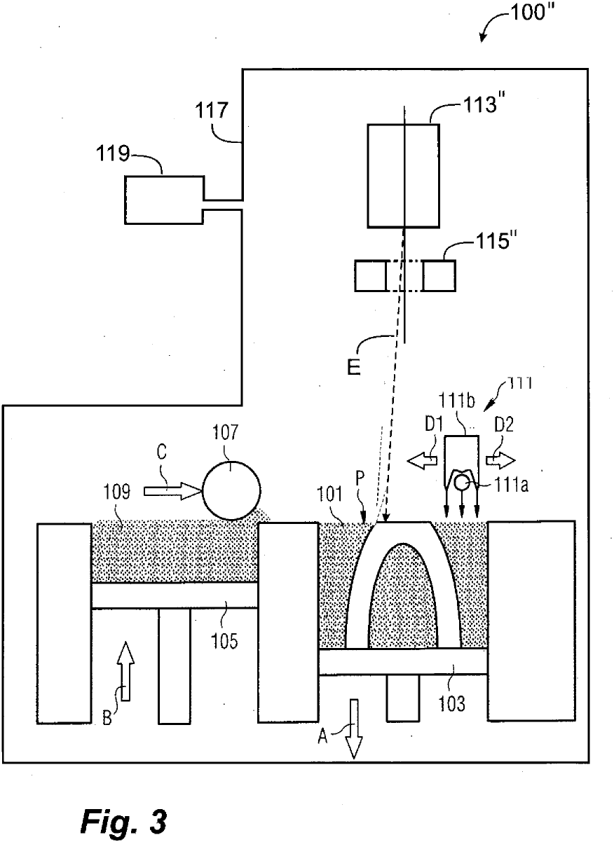

FIG. 3 also shows an arrangement 100″ which is partly similar to the arrangement according to FIG. 1. In this case too, the parts corresponding to FIG. 1 are marked with the same reference numbers as there. The arrangement 100″ is configured as an EBM processing arrangement, i.e. instead of a processing laser and the associated scanner, an electron beam tube 113″ with associated coordinate-controlled deflection unit 115″ is used.

The deflection unit 115″ deflects an electron beam E generated by the electron beam tube 113″ to any points on the surface of the powder bed 101, which are defined by production drawings of the metal product P with regard to its individual layers. By means of a power operating current control (not shown) of the electron tube 113″, the power of the electron beam E and thus the temperature attainable at the point of impact can be controlled almost without inertia. This enables, among other things, the precise T-controlled execution of sintering or melting steps on the one hand and subsequent tempering steps of the applied metal layer on the other hand.

In addition, the entire arrangement is housed here in a vacuum chamber 117, to which a vacuum generator 119 is assigned to generate a high vacuum in the vacuum chamber during the manufacturing process of a product.

With regard to the use and the constructive design of the NIR radiation source 111, reference is hereby made to the corresponding embodiments in FIG. 1. At present, it is considered advantageous to place the NIR radiation source 111 in the vacuum chamber 117 as well; in principle, however, the radiator module could also be placed outside the vacuum chamber and the NIR radiation directed onto the product surface through an NIR-permeable window and, optionally, corresponding mirrors.

Furthermore, the embodiment of the invention is also possible in a number of variations of the examples shown here and aspects of the invention highlighted above.

1. 3D-metal-printing method for producing a spatial metal product essentially from a metal powder or metal filaments;
wherein the powder or the filaments is/are built up layer-by-layer by applying starting material layers to a respective previously produced layer and selectively locally heating predetermined points of the layer above a sintering or melting temperature of the powder and sintering or fusing the melted points with the underlying layer and optionally tempering the points;
wherein the respective newly applied starting material layer and optionally at least one underlying layer is preheated to a temperature with a predetermined difference to the melting temperature by irradiation in a flat or migrating manner of near IR radiation, in particular with a radiation density maximum in the wavelength range between 0.8 and 1.5 µm, and/or is post-treated following the local heating of predetermined points for thermal stress equalization; and
wherein the near IR radiation is sequentially irradiated in sections into partial sections of the total area of the respective starting material layer, wherein the selective local heating above the sintering or melting temperature is carried out in each case for predetermined points within a preheated partial section.

2. 3D-metal-printing method according to claim 1, wherein the power density of the near IR radiation irradiated over a surface is above 1 MW/m².

3. 3D-metal-printing method according to claim 1, wherein the radiation of at least one halogen radiator, in particular a plurality of halogen radiators, with a radiator temperature in particular also in the range of 2900 K to 3200 K is used as near IR radiation.

4. 3D-metal-printing method according to claim 1, wherein the selective local heating of predetermined points is affected by scanning the starting material layer with an electron or laser beam.

5. 3D-metal-printing method according to claim 1, wherein preheating to a material-specific preset temperature, in particular in the range between 600 and 1100° C., more particularly in the range between 700 and 1000° C., is carried out and is controlled in particular by time and/or radiation density control of the irradiation of the near IR radiation.

6. A system for 3D metal printing, comprising:
a worktable as a base for layer-by-layer structure of a spatial metal product;
a powder application device for sequential application of starting material layers of a metal powder or starting material filaments in the area of the worktable;
a surface heating device for surface heating of each new starting material layer for preheating or thermal post-treatment, the surface-heating device having an NIR irradiation device for irradiating near IR radiation, in particular with a radiation density maximum in the wavelength range between 0.8 and 1.5 µm, onto a predetermined surface in the region of the worktable; and
a mechanism providing selective local heating of predetermined points of the new starting material layer above a sintering or melting temperature of the metal powder;
wherein the surface heating device is designed to radiate the near IR radiation sequentially into subsections of the total area of the respective initial material layer; and
wherein the means of inducing selective local heating are configured to induce local heating at specified points within one or another of the pre-heated subsections.

7. System according to claim 6, wherein the mechanism providing selective local heating of predetermined points of a previously applied starting material layer comprises a laser with a downstream scanner for point-by-point irradiation of near NIR radiation or visible light in the long-wave range onto the predetermined points.

8. System according to claim 6, wherein the mechanism providing selective local heating of predetermined points of a previously applied starting material layer comprises an electron beam generator for the point-by-point irradiation of electron radiation onto the predetermined points, and the arrangement is arranged in a vacuum chamber subjected to a high vacuum.

9. System according to claim 6, wherein the NIR irradiation device comprises at least one halogen radiator, in particular a plurality of halogen radiators, with a reflector associated such that the radiation of the or each infrared radiator is concentrated in the direction towards the worktable.

10. System according to claim 9, wherein the halogen radiator or the plurality of halogen radiators with associated reflector is mounted above the worktable so as to be movable in at least one axial direction of an XY plane.

11. System according to claim 9, wherein the halogen radiator or radiators is/are designed for operation at a radiator temperature in the range of 2900 K to 3200 K.
